(19) United States
(12) Patent Application Publication
(10) Pub. No.: US 2008/0045061 A1
(43) Pub. Date: Feb. 21, 2008

(54) Electronic Control Unit Casing and Electrical Connector

(76) Inventor: Toshiaki Hayashi, Aich (JP)

Correspondence Address: BARLEY SNYDER, LLC, 1000 WESTLAKES DRIVE, SUITE 275, BERWYN, PA, 19312, US

(21) Appl. No.: 11/838,953

(22) Filed: Aug. 15, 2007

(30) Foreign Application Priority Data
Aug. 17, 2006 (JP) 2006-222381

(51) Int. Cl. H01R 13/64

(52) U.S. Cl. 439/246

(57) ABSTRACT

An electronic control unit includes an electronic control unit casing having an electrical connector receiving opening. A circuit board is arranged in the electronic control unit casing such that an end of the circuit board extends into the electrical connector receiving opening. A rear end of the electrical connector is positioned in the electrical connector receiving opening such that the circuit board is arranged between a top surface and a bottom surface of the electrical connector. The electrical connector has a plurality of contacts electrically connected with the circuit board. A seal groove fixes the electronic control unit casing in the electrical connector receiving opening. The seal groove includes an upper groove formed on a top surface of the electrical connector and a lower groove formed on a bottom surface of the electrical connector. The upper groove is positioned closer to the rear end than the lower groove.

### CROSS-REFERENCE TO RELATED APPLICATIONS

This application claims the benefit of the filing date under 35 U.S.C. § 119(a)-(d) of Japanese Patent Application No. 2006-222381, filed Aug. 17, 2006.

### FIELD OF THE INVENTION

The present invention relates to an electronic control unit comprising an electronic control unit casing, an electrical connector, and a circuit board wherein the electronic control unit has waterproof properties and is compact.

### BACKGROUND

An in-vehicle electronic control unit used for controlling an engine and the like is sometimes installed within an engine room. Because the electronic control unit is installed in an engine room, the electronic control unit casing and the electrical connector that constitute the electronic control unit need to have a waterproof structure. Examples of electronic control units and electrical connectors having a waterproof structure are illustrated in Japanese Patent Publication No. 10-172643, Japanese Patent Publication No. 10-340755, Japanese Patent Publication No. 2004-186039, and Japanese Patent Publication No. 2006-100252.

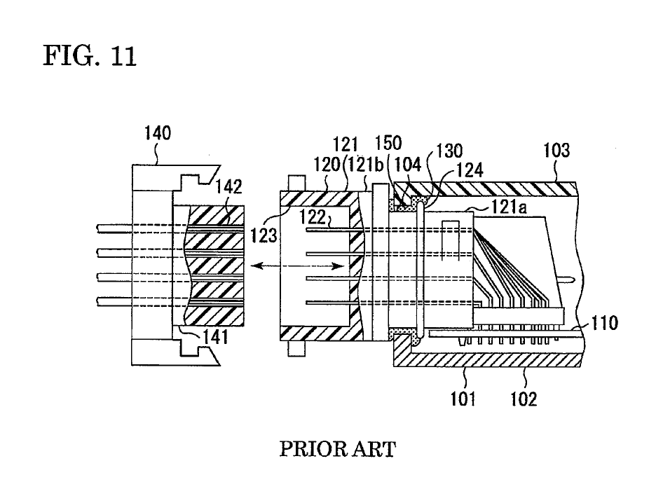

The electronic control unit disclosed in Japanese Patent Publication No. 2006-100252 will be described herein with reference to FIG. 11. As shown in FIG. 11, the electronic control unit comprises a housing 101 consisting of a housing member 102 and a cover 103. At the left side of the housing 101 is an opening 104 for mounting an electrical connector 120. The housing member 102 is a rectangular flat plate member and is made of die cast aluminum. The cover 103 is made of a resin and has an opening on a bottom side thereof. The housing 101 is assembled so that the opening of the cover 103 is closed by the housing member 102. A circuit board 110 provided with a plurality of electronic components (not shown) is fixed within the housing 101.

The electrical connector 120 has contacts 122 mounted on a connector main body 121 made of resin. The connector main body 121 has a first member 121a positioned within the housing 101 in an interior of the opening 104, and a second member 121b, which is larger than the first member 121a, positioned outside the housing 101. The connector 120 interconnects the electronic components (not shown) on the circuit board 110 inside the housing 101 with external devices (not shown) via the contacts 122. One end of the contacts 122 is soldered in a state being inserted through the circuit board 110 within the housing 101. Another end of the contacts 122 projects from an inside wall of a concave member 123 formed on the second member 121b. By engaging and inserting a connector main unit 141 of a mating connector 140 in the concave member 123 of the electrical connector 120, the contacts 122 of the electrical connector 120 and sockets 142 of the mating connector 140 are engaged and electrically connected.

A flange 124 is provided within the housing 101 on an outer peripheral surface of the first member 121a and inward from the opening 104. A groove is formed by the second member 121b of the connector main body 121 and the flange 124. A waterproof seal material 130 is placed in the groove. The waterproof seal material 130 may be a liquid adhesive type waterproof seal material including silicone rubber, butyl rubber, and the like. The waterproof seal material 130 is therefore interposed in a gap at the opening 104 provided on the housing 101. The waterproof seal material 130 is prevented from flowing to an outside of the housing 101 by the second member 121b. The waterproof seal material 130 is also prevented from flowing to the inside by the flange 124.

A protrusion 150 is integrally formed on a center of a top surface of the opening 104 at the cover 103. The protrusion 150 has a circular cone or pyramid shape and has a cross-section that becomes smaller toward a downward tip thereof. The tip of the protrusion 150 is in contact with a top surface of the first member 121a. When the temperature inside the housing 101 rapidly drops due to the electronic control unit getting wet or the like, and the internal pressure becomes lower than the external pressure, the protrusion 150 is in contact with and supports the top surface of the smaller part 121a of the connector 120. Thus, it is possible to prevent sagging in the compression direction of the waterproof seal material 130 of the top surface of the cover 103 corresponding to the opening 104, and it is possible to ease the stress generated at the waterproof seal groove 130.

There is still a need, however, for electronic control units to be designed to have a more compact size because of the relationship with other devices installed within the engine room.

### BRIEF SUMMARY

It is therefore an object of the present invention to provide an electronic control unit that can be made more compact while maintaining the waterproof function.

This and other objects are achieved by an electronic control unit comprising an electronic control unit casing having an electrical connector receiving opening. A circuit board is arranged in the electronic control unit casing such that an end of the circuit board extends into the electrical connector receiving opening. An electrical connector has a front end and an opposing rear end. The rear end of the electrical connector is positioned in the electrical connector receiving opening such that the circuit board is arranged between a top surface and a bottom surface of the electrical connector. The electrical connector has a plurality of contacts electrically connected with the circuit board. A seal groove fixes the electronic control unit casing in the electrical connector receiving opening. The seal groove includes an upper groove formed on a top surface of the electrical connector and a lower groove formed on a bottom surface of the electrical connector. The upper groove is positioned closer to the rear end than the lower groove.

### DETAILED DESCRIPTION OF DRAWINGS

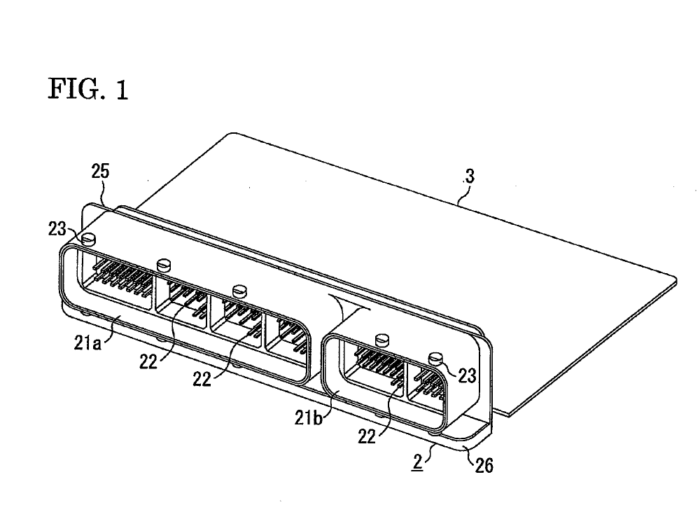

FIG. 1 is a top perspective view of an electrical connector and a circuit board according to an embodiment of the present invention.

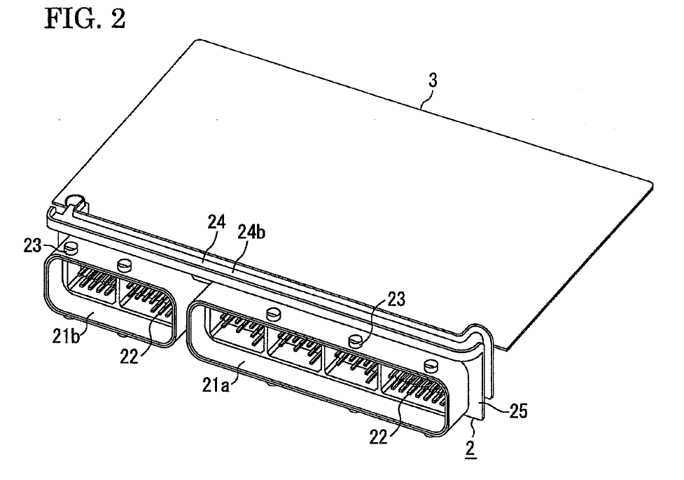

FIG. 2 is a bottom perspective view of the electrical connector and the circuit board of FIG. 1.

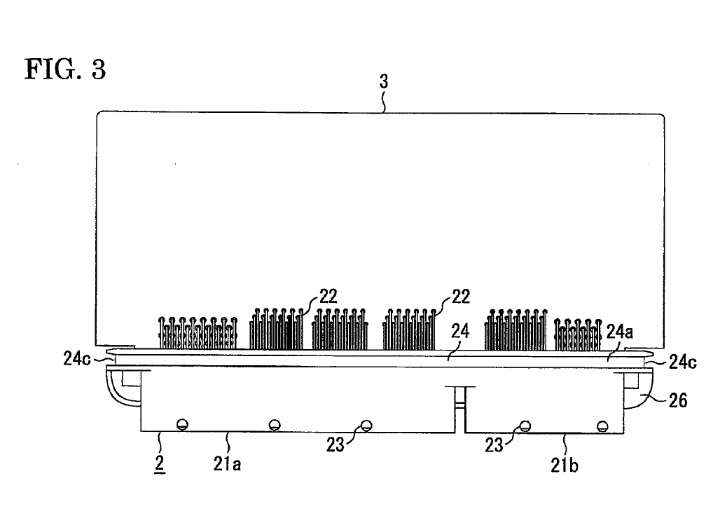

FIG. 3 is a plan view of the electrical connector and the circuit board of FIG. 1.

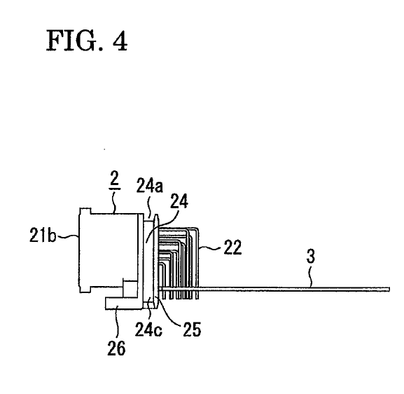

FIG. 4 is a side view of the electrical connector and the circuit board of FIG. 1.

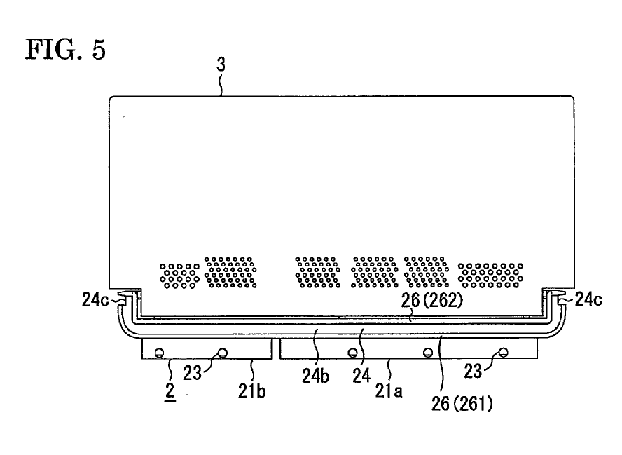

FIG. 5 is a bottom view of the electrical connector and the circuit board of FIG. 1.

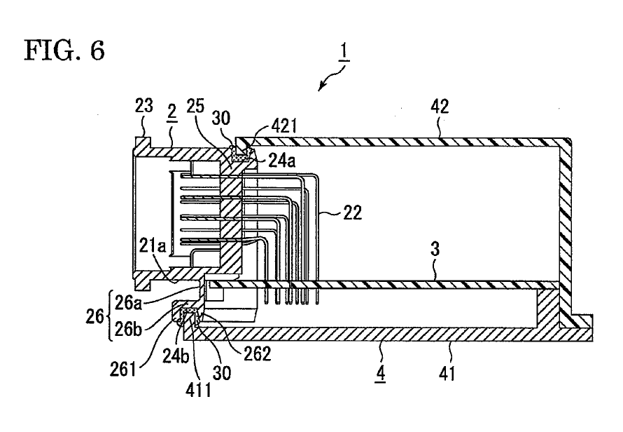

FIG. 6 is a side cross-sectional view of the electrical connector and the circuit board of FIG. 1 shown with an electronic control unit casing.

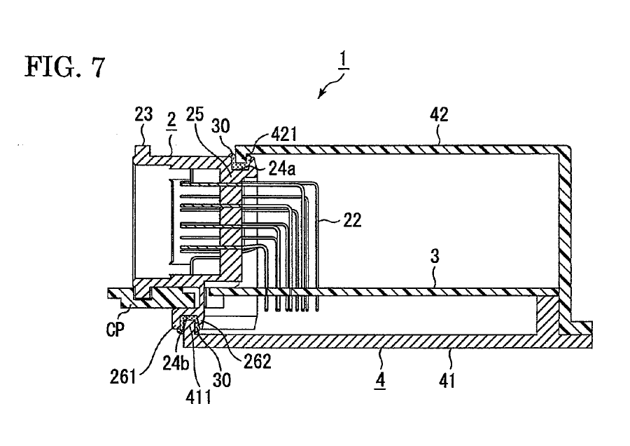

FIG. 7 is a side cross-sectional view of the electrical connector and the circuit board of FIG. 1 shown with the electronic control unit casing and a cam plate of a mating connector.

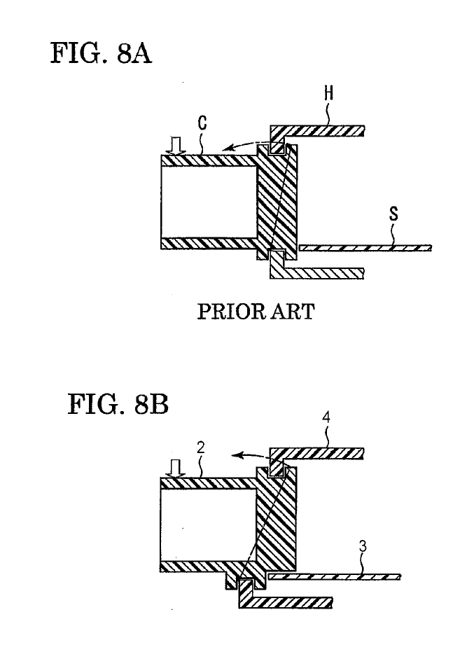

FIG. 8A is a simplified side cross-sectional view of an electrical connector, housing, and circuit board of an electronic control unit according to the prior art.

FIG. 8B is a simplified side cross-sectional view of an electrical connector, electronic control unit casing, and circuit board of the electronic control unit according to the invention.

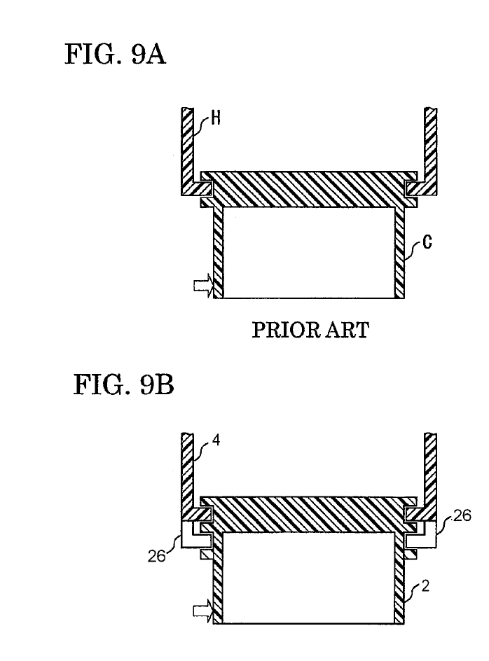

FIG. 9A is a simplified plan cross-sectional view of the electrical connector and the housing of the electronic control unit according to the prior art.

FIG. 9B is a simplified plan cross-sectional view of the electrical connector and the electronic control unit casing of the electronic control unit according to the invention.

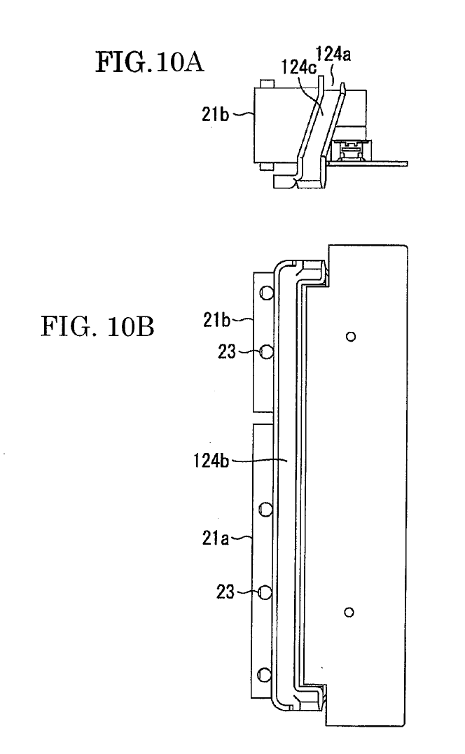

FIG. 10A is a side view of an electronic control unit according to an alternate embodiment of the present invention.

FIG. 10B is a plan view of the electronic control unit of FIG. 10A.

FIG. 11 is a partial side cross-sectional view of an electronic control unit according to the prior art.

### DETAILED DESCRIPTION OF THE EMBODIMENT(S)

FIG. 6 shows an electronic control unit 1 that may be arranged, for example, within an engine room of an automobile. The electronic control unit 1 includes an electronic control unit casing 4 and an electrical connector 2 and a circuit board 3. The electrical connector 2 comprises a housing, which may be formed from a resin. A base 25 is integrally formed with the housing. As shown in FIGS. 1-2, hoods 21a, 21b extend from the base 25 and form a substantial sleeve shape. The hoods 21a, 21b are arranged on a front end of the electrical connector 2, and the base 25 is arranged on a rear end of the electrical connector 2. The hoods 21a, 21b have a substantially rectangular shaped opening. An interior of the hood 21a is divided into, for example, four sections. An interior of the hood 21b is divided into, for example, two sections. Top and bottom surfaces of the hoods 21a, 21b are provided with a plurality of cam followers 23 configured to engage with a groove provided in a cam plate CP (FIG. 7) of a mating connector (not shown). A flange 26 is arranged below the hoods 21a, 21b, as shown in FIG. 6. The flange 26 has a substantially L-shaped cross-section and includes a vertical part 26a that extends from a bottom surface of the hoods 21a, 21b and a horizontal member 26b that extends at substantially perpendicular to the vertical part 26a. A gap is formed between the flange 26 and the hoods 21a, 21b in a direction of width.

A substantially concave seal groove 24 is formed about an outer periphery of the electrical connector 2 and comprises an upper groove 24a (FIG. 6), a lower groove 24b (FIGS. 2 and 5-6), and side grooves 24c (FIG. 3). As shown in FIG. 6, the lower groove 24b is offset closer to the front end of the electrical connector 2 than the upper groove 24a. The upper groove 24a is formed in a top surface of the electrical connector 2 in the top surface of the base 25 adjacent to the top surface of the hoods 21a, 21b and extends in a direction of width of the electrical connector 2. The upper groove 24a is therefore formed within a projection plane of the top surface of the base 25. As shown in FIGS. 2 and 6, the lower groove 24b is formed in the bottom surface of the electrical connector 2 in a bottom surface of the flange 26 below the bottom surface of the hoods 21a, 21b. As shown in FIG. 5, the flange 26 has projected lines 261, 262 at both ends in latitudinal direction of the horizontal member 26b, and the lower groove 24b is formed by the bottom surface of the horizontal member 26b and the projected lines 261, 262. The lower groove 24b is therefore formed within a projection plane of the bottom surface of the hoods 21a, 21b. As shown in FIG. 5, ends of the lower groove 24b extend toward the rear end of the electrical connector 2 such that the lower groove 24b communicates with the side grooves 24c. The side grooves 24c connect the upper groove 24a and the lower groove 24b. As shown in FIG. 3, the side grooves 24c are formed on both side surfaces of the electrical connector 2 in the base 25 and extend in a substantially vertical direction. Alternatively, the side grooves 124c may be inclined toward the lower groove 124b from the upper groove 124a, as shown in FIGS. 10A-10B.

The electrical connector 2 is provided with a plurality of contacts 22 that contact mating contacts (not shown) of the mating connector (not shown). The contacts are substantially L-shaped such that the contacts have a first end that extends substantially parallel to a direction of extension of the hoods 21a, 21b and a second end extending substantially perpendicular to the direction of the extension of the hoods 21a, 21b. The first end of the contacts 22 extend from the hoods 21a, 21b through the base 25 and then the second ends of the contacts 22 extend downward to the circuit board 3. The second ends of the contacts 22 are electrically connected to a conductive pattern (not shown) on the circuit board 3.

As shown in FIG. 6, the circuit board 3 may be provided with various types of electronic components (not shown) for controlling, for example, the engine and is installed between the bottom surface and the top surface of the electrical connector 2 adjacent to the bottom surface of the electrical connector 2 and substantially perpendicular to the base 25 of the electrical connector 2. The circuit board 3 has one end at the electrical connector 2 positioned closer to the front end of the electrical connector 2 than the upper groove 24a and positioned closer to the rear end of the electrical connector 2 than the lower groove 24b. This type of positioning is a result of the lower groove 24b being offset further toward the front end of the electrical connector 2 than the upper groove 24a. For example, the end of the circuit board 3 positioned closer to the front end of the electrical connector 2 than the upper groove 24a by a distance equal with or greater than a dimension of width of the upper groove 24a. As a result, it is possible to shorten the length of the electronic control unit casing 4 on which the circuit board 3 is supported by that amount. Additionally, it is possible to have the circuit board 3 installed overlapping with the electrical connector 2 in a planar view of the electronic control unit casing 4. As a result, when it is not necessary to change the length of the circuit board 3, it is possible to shorten the length of the electronic control unit casing 4. Also, when it is not necessary to change the length of the electronic control unit casing 4, it is possible to lengthen the length of the circuit board 3.

As shown in FIG. 6, the electronic control unit casing 4 includes a cover 41 and a housing member 42. The cover 41 may be made, for example, from die cast aluminum. The housing member 42 can be made, for example, from resin. The housing member 42 has an electrical connector receiving opening and a downward opening. The downward opening is substantially closed by the cover 41. Adjacent the electrical connector receiving opening, the cover 41 and the housing member 42 have flanges 411, 421, respectively, extending in a direction of width thereof.

The cover 41 and the housing member 42 are fixed via a waterproof seal material 30. The electronic control unit casing 4 is fixed to the electrical connector 2 via the waterproof seal material 30. The specific material of the waterproof seal material 30 of the present invention does not matter and broad application of seal materials such as silicone rubber, butyl rubber and the like are conceivable. To fix the electronic control unit casing 4 to the electrical connector 2, the waterproof seal material 30 is filled into the seal groove 24. The rear end of the electrical connector 2 is positioned inside the electronic control unit casing 4 such that the circuit board 3 is supported on the cover 41, as shown in FIG. 5. The flange 411 of the cover 41 and the flange 421 of the housing member 42 are inserted into the seal groove 24 filled with the waterproof seal material 30. The contacts 22 through the base 25 of the electrical connector 2 are arranged within the electronic control unit casing 4, and the circuit board 3 that is electrically connected with the contacts 22 is also arranged within the electronic control unit casing 4. Because the waterproof properties of the electrical connector 2 and the electronic control unit casing 4 and the waterproof properties of the cover 41 and the housing member 42 are ensured by the waterproof seal material 30, the contacts 22 and the circuit board 3 held inside the electronic control unit casing 4 are safe from the penetration of water from an outside thereof. Further, when the mating connector (not shown) is connected with the electrical connector 2, it is possible to hold part of the cam plate CP inside the gap formed between the flange 26 and the hoods 21a, 21b, as shown in FIG. 7. Therefore, the electronic control unit 1 can prevent the cam plate CP from dropping out.

Additionally, the joining strength of the electrical connector 2 and the electronic control unit casing 4 is strong in relation to external force. This feature is described with reference to FIGS. 8A-8B. FIG. 8A shows a simplified electrical connector C, housing H, and circuit board S of an electronic control unit according to Japanese Patent Publication No. 10-172643. FIG. 8B shows a simplified view of the electrical connector 2, the electronic control unit casing 4, and the circuit board 3 of the electronic control unit 1 according to the invention. If an external force is applied in a downward direction, as shown by an arrow in FIGS. 8A-8B, an attempt is made to rotate the electrical connectors C, 2 in a counterclockwise direction. The rotation radius and the rotation trajectory of the electrical connectors C, 2 are shown by the dot-dash line. As shown in FIG. 8A, the moving trajectory at a top end of the electrical connector C is substantially parallel with a longitudinal direction of the housing H. In contrast, the moving trajectory at a top end of the electrical connector 2 corresponds to a direction pushing the electronic control unit casing 4 upward. Therefore, compared to the electrical connector C, the electrical connector 2 has a tendency to move in a direction for which the top end of the electrical connector 2 is not easily removed from the electronic control unit casing 4 when the external force is applied thereto, and the joining strength of the electrical connector 2 and the electronic control unit casing 4 is strong.

Further, the electrical connector 2 and the electronic control unit casing 4 have high strength in relation to external force received at the electrical connector side. This feature is described with reference to FIGS. 9A-9B. If an external force is applied in a sideways direction, as shown by an arrow in FIGS. 9A-9B, both the electrical connector C and the electrical connector 2 receive this external force on a flange end of the housing H and the electronic control unit casing 4 facing the side surface of the electrical connector C, 2. Because in the electronic control unit 1 according to the invention, both ends of the lower groove 24b are bent to the back end side of the electrical connector 2, even at the bent member, it is possible to receive this external force by the flange 26 and the electronic control unit casing 4. In other words, compared to the electrical connector C, the electrical connector 2 has higher strength in relation to this external force because there is an increase in the surface area in the planar direction that receives the external force in the horizontal direction.

The foregoing illustrates some of the possibilities for practicing the invention. Many other embodiments are possible within the scope and spirit of the invention. For example, it is possible to provide the seal groove 24 on the electronic control unit casing 4 instead of the electrical connector 2. In this case, the flanges of the cover 41 and the housing member 42 would be provided on the side of the electrical connector 2. Further, the lower groove 24b may be formed directly on the bottom surfaces of the hoods 21a, 21b instead of on the flange 26. It is also possible to provide an upper member on the flange 26 and to provide the upper groove 24a thereon. It is, therefore, intended that the foregoing description be regarded as illustrative rather than limiting, and that the scope of the invention is given by the appended claims together with their full range of equivalents.

What is claimed is:

1. An electronic control unit, comprising:
an electronic control unit casing having an electrical connector receiving opening;
a circuit board arranged in the electronic control unit casing such that an end of the circuit board extends into the electrical connector receiving opening;
an electrical connector having a front end and an opposing rear end, the rear end of the electrical connector being positioned in the electrical connector receiving opening such that the circuit board is arranged between a top surface and a bottom surface of the electrical connector, the electrical connector having a plurality of contacts electrically connected with the circuit board; and
a seal groove that fixes the electronic control unit casing in the electrical connector receiving opening, the seal groove including an upper groove formed on a top surface of the electrical connector and a lower groove formed on a bottom surface of the electrical connector, the upper groove being positioned closer to the rear end than the lower groove.

2. The electronic control unit of claim 1, wherein the end of the circuit board extending into the electrical connector receiving opening is positioned closer to the front end of the electrical connector than the upper groove.

3. The electronic control unit of claim 1, wherein the circuit board is arranged adjacent to the bottom surface of the electrical connector.

4. The electronic control unit of claim 1, wherein the lower groove is positioned closer to the front end of the electrical connector than the upper groove by a distance equal with or greater than a dimension of width of the upper groove.

5. The electronic control unit of claim 1, wherein a waterproof seal material is provided in the seal groove.

6. The electronic control unit of claim 1, wherein the electronic control unit includes at least one flange that extends into the electrical connector receiving opening and engages in the upper and lower grooves.

7. The electronic control unit of claim 1, wherein the contacts are substantially L-shaped.

8. The electronic control unit of claim 1, wherein the electrical connector includes at least one hood formed on the front end thereof.

9. The electronic control unit of claim 8, wherein the lower groove is formed on a flange spaced from a bottom surface of the hood.

10. The electronic control unit of claim 8, wherein the hood includes at least one cam follower for engaging with a cam plate of a mating connector.

11. The electronic control unit of claim 1, wherein the electronic control unit casing includes a housing member and a cover, the cover supporting the circuit board in the electronic control unit casing.

12. The electronic control unit of claim 11, wherein the housing member includes the electrical connector receiving opening.

13. The electronic control unit of claim 11, wherein the housing member is formed from a resin and the cover is formed from a die cast aluminum.

14. The electronic control unit of claim 1, wherein the seal groove includes side grooves formed on side surfaces of the electrical connector that connect the upper and lower seal grooves.

15. The electronic control unit of claim 14, wherein ends of the lower groove extend toward the rear end of the electrical connector and communicate with the side grooves.
